(19) United States
(12) Patent Application Publication
(10) Pub. No.: US 2006/0023167 A1
(43) Pub. Date: Feb. 2, 2006

(54) ILLUMINATION SYSTEM FOR PROJECTION DISPLAY APPLICATIONS

(76) Inventors: Po Liang Chiang, Taipei City (TW); Hsueh-Chen Chang, I-Lan Hsien (TW); Ci Guang Peng, Chia-I City (TW); Yi Wei Liu, Taipei Hsien (TW); Hsin Wen Tsai, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/905,806

(22) Filed: Jan. 21, 2005

(30) Foreign Application Priority Data
Aug. 2, 2004 (TW) 093123109

(51) Int. Cl. G03B 21/00

(52) U.S. Cl. 353/31

(57) ABSTRACT

An illumination system suited for projection display applications is disclosed. The illumination system according to this invention includes a red light-emitting diode (R-LED) light source array, a green light-emitting diode (G-LED) light source array, and a blue light-emitting diode (B-LED) light source array. In one preferred embodiment, the R/G/B-LED light source arrays are coupled to different sides of an x-cube component. Light beams emanated from respective light source arrays are combined by the x-cube component, thereby generating a white-light source for display purposes.

### BACKGROUND OF INVENTION

1. Field of the Invention

The invention relates to an illumination system, and more particularly, to an illumination system for optical projection apparatuses.

2. Description of the Prior Art

Projectors are devices utilizing optical projections to cast images onto large size screens. According to different light valves used, projectors can be roughly classified into categories including Cathode Ray Tube (CRT) projectors, Liquid Crystal Display (LCD) projectors, Digital Light Processing (DLP) projectors, and Liquid Crystal on Silicon (LCoS) projectors. The LCD projectors operate by utilizing light beams to penetrate LCD panels, hence they are also referred to as penetrating projectors. LCoS and DLP projectors on the other hand operate by light reflection principles to produce images, and are hence also referred to as reflective projectors.

The fundamental principle of the LCoS projectors is essentially similar to that of the LCD projectors, except the light signals controlling the projective image to the frame of the LCoS projectors are adjusted by the LCoS panel. The LCoS panel is formed by utilizing a silicon chip as an electrical circuit substrate and a reflective layer, coating the chip with a liquid crystal layer, and finally packing with a glass panel. In contrast to LCD projectors that utilize a light source to penetrate the LCD for performing various adjustments, hence also referred to as penetrating projectors, the LCoS projectors are reflective projectors that utilize a reflective architecture, in which the light emitted from the light source is not penetrated through the LCoS panel.

Despite the fact that the light sources utilized by most projectors on the market today are high pressure mercury lamps having the advantage of high brightness, the cost of such lamps are considerably more expensive, much larger in size, and have a much shorter life expectancy. Since the mercury lamps often need to be replaced within a short period of time, the industry is looking for a way to develop a much more suitable solution for replacing the light source of projectors.

### SUMMARY OF INVENTION

It is therefore an objective of the present invention to provide an illumination system for optical projection apparatuses for improving the illumination system of the prior art.

According to the present inventions, an illumination system for projection apparatuses comprises a red light-emitting diode (R-LED) light source array, a green light-emitting diode (G-LED) light source array, and a blue light-emitting diode (B-LED) source array, in which red, green, and blue light beams are emanated from the R/G/B-LED light source arrays via a light combination device for generating a white-light source. Each R/G/B-LED light source array includes a substrate and a plurality of light-emitting diodes fixed on the substrate and the light-emitting diodes are positioned toward the light combination device. The light combination device can be a horizontal crossed prism or an x-cube light combination prism component. Alternatively, the light combination device can also be a horizontal crossed reflector or an x-plate light combination component.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective diagram showing the illumination system for projection apparatuses according to the first embodiment of the present invention.

FIG. 2 is a three-dimensional diagram showing the light combination device according to the first embodiment of the present invention.

FIG. 3 is a perspective diagram showing the illumination system for projection apparatuses according to the second embodiment of the present invention.

FIG. 4 is a three-dimensional diagram showing the light combination device according to the second embodiment of the present invention.

FIG. 5 is a perspective diagram showing the illumination system for projection apparatuses according to the third embodiment of the present invention.

FIG. 6 is a three-dimensional diagram showing the light combination device according to the third embodiment of the present invention.

### DETAILED DESCRIPTION

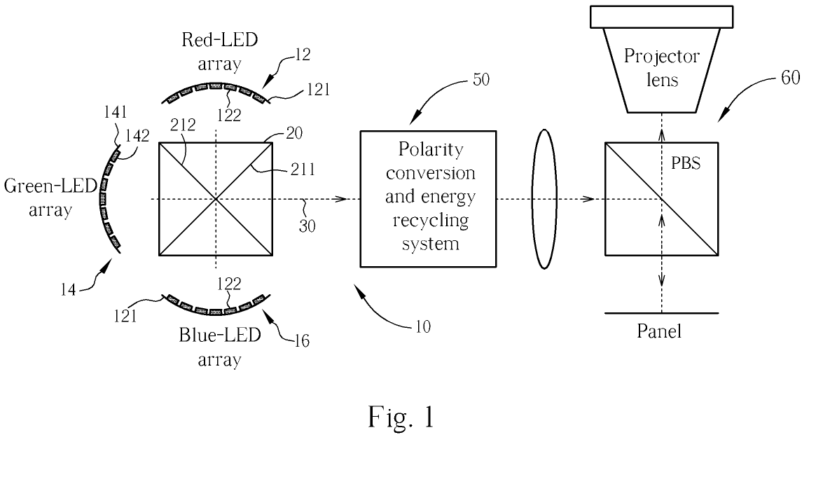

Please refer to FIG. 1. FIG. 1 is a perspective diagram showing the illumination system 10 for projection apparatuses according to the first embodiment of the present invention. According to the first embodiment of the present invention, the illumination system for projection apparatuses comprises a red light-emitting diode (R-LED) light source array 12, a green light-emitting diode (G-LED) light source array 14, and a blue light-emitting diode (B-LED) source array 16, in which red, green, and blue light beams are emanated from the R/G/B-LED light source arrays 12, 14, 16 and combined via a light combination device 20 for generating a white-light source. As shown in FIG. 1, the R-LED light source array 12 includes a curved substrate 121 and a plurality of R-LEDs 122 fixed on the curved substrate 121. The G-LED light source array 14 includes a curved substrate 141 and a plurality of G-LEDs 142 fixed on the curved substrate 141. The B-LED light source array 16 includes a curved substrate 161 and a plurality of B-LEDs 162 fixed on the curved substrate 161. All of the light-emitting diodes listed are positioned toward the light combination device.

According to the first embodiment of the present invention, the curved substrates 121, 141, and 161 are mirror substrates with equal curvatures positioned in a corresponding manner around the light combination device 20, where the maximum light intensity axial of the R-LED 122 is roughly pointed toward the center of the light combination device 20. It should be noted that the substrates 121, 141, and 161 of the R/G/B-LED light source arrays 12, 14, 16 of the illumination system 10 can also be flat substrates instead of curved substrates. Alternatively, a similar effect can be achieved by changing the arrangement of the light-emitting diodes 122 such as tilting the diodes at an angle, thereby causing the maximum light intensity axial to point toward the center of the light combination device 20. In addition, the curved substrates 121, 141, and 161 should also be comprised of heat radiating materials.

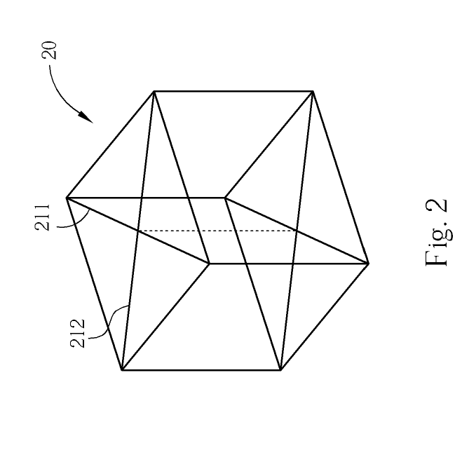

According to the first embodiment of the present invention, the light combination device 20 can be a traditional horizontal crossed prism or a so-called “X-Cube” light combination prism component. Please refer to FIG. 2. FIG. 2 is a three-dimensional diagram showing the light combination device 20 according to the first embodiment of the present invention. By using the X-Cube light combination prism component as an example, the X-Cube light combination prism component includes a light converting surface 211 that enables the reflection of blue light beams and the penetration of green light beams and a light converting surface 212 that enables the reflection of red light beams and the penetration of green light beams. By combining the red, green, and blue light beams emanated from the R/G/B-LED light source arrays 12, 14, 16 via the light combination device 20, a white light beam 30 is generated and transmitted back to a polarity conversion and energy recycling system 50, which can be a combination of lens array and PCS or a recyclable light pipe device. After exiting from the polarity conversion and energy recycling system 50, the polarized beams are transmitted through the lens group and an optical engine 60 and are finally projected to a screen by the projection lens (not shown).

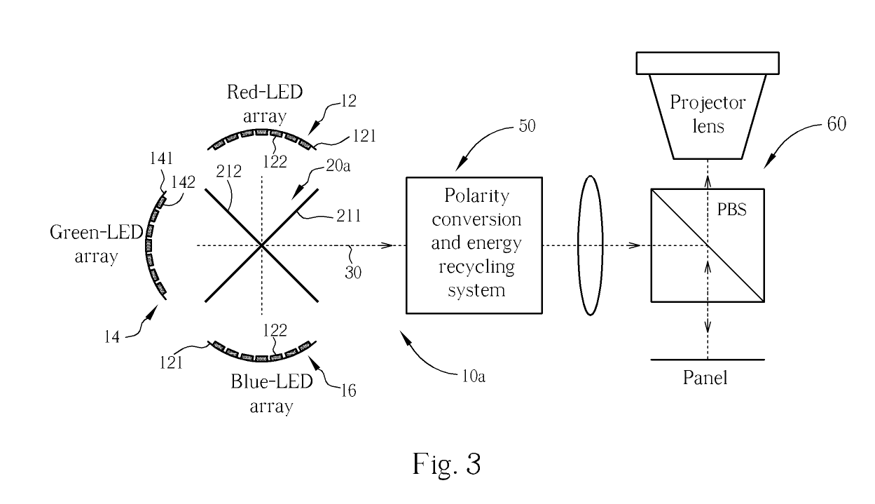

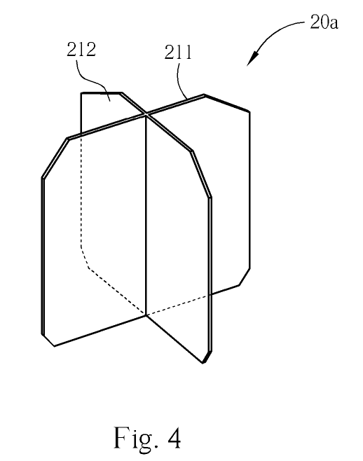

Please refer to FIG. 3 and FIG. 4. FIG. 3 is a perspective diagram showing the illumination system 10a for projection apparatuses and FIG. 4 is a three-dimensional diagram showing the light combination device 20a. According to the second embodiment of the present invention, red, green, and blue light beams are emanated from the R/G/B-LED light source arrays 12, 14, 16 and combined to form a white-light source by the light combination device 20a. As shown in FIG. 3, the R-LED light source array 12 includes a curved substrate 121 and a plurality of R-LEDs 122 fixed on the curved substrate 121. The G-LED light source array 14 includes a curved substrate 141 and a plurality of G-LEDs 142 fixed on the curved substrate 141. The B-LED light source array 16 includes a curved substrate 161 and a plurality of B-LEDs 162 fixed on the curved substrate 161.

According to the second embodiment of the present invention, the curved substrates 121, 141, and 161 are mirror substrates with equal curvatures positioned in a corresponding manner around the light combination device 20a, where the maximum light intensity axial of the R-LED 122 is roughly pointed toward the center of the light combination device 20a. It should be noted that the substrates 121, 141, and 161 of the R/G/B-LED light source arrays 12, 14, 16 of illumination system 10a can also be flat substrates instead of curved substrates. Alternatively, a similar effect can be achieved by changing the arrangement of the light-emitting diodes 122 such as tilting the diodes at an angle, thereby causing the maximum light intensity axial to point toward the center of the light combination device 20a.

As shown in FIG. 4, the light combination device 20a can be a traditional horizontal crossed prism or a so-called “X-Plate” light combination prism component. By using the X-Plate light combination prism component as an example, the X-Plate light combination prism component includes a light converting surface 211 that enables the reflection of blue light beams and the penetration of green light beams and a light converting surface 212 that enables the reflection of red light beams and the penetration of green light beams. By combining the red, green, and blue light beams emanated from the R/G/B-LED light source arrays 12, 14, 16 via the light combination device 20a, a white light beam 30 is generated and transmitted back to a polarity conversion and energy recycling system 50, which can be a combination of a lens array and PCS or a recyclable light pipe device. After exiting from the polarity conversion and energy recycling system 50, the polarized beams are transmitted through the lens group and an optical engine 60 and are finally projected to a screen by the projection lens (not shown).

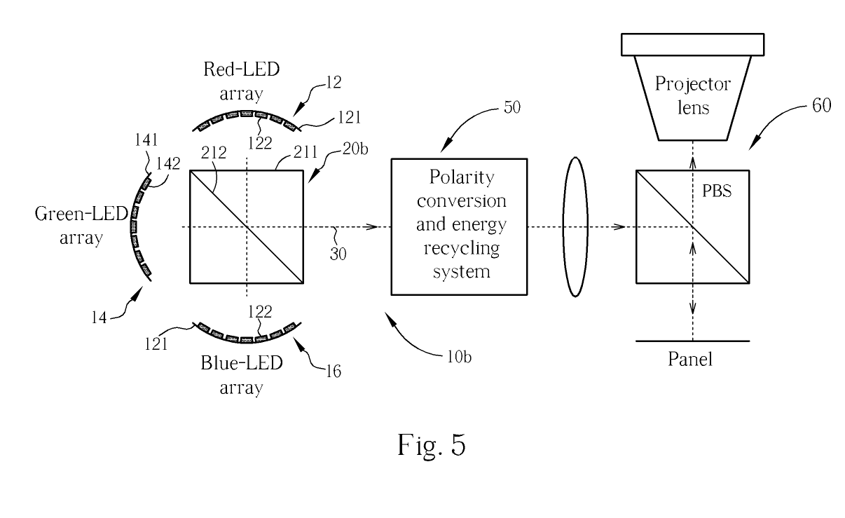

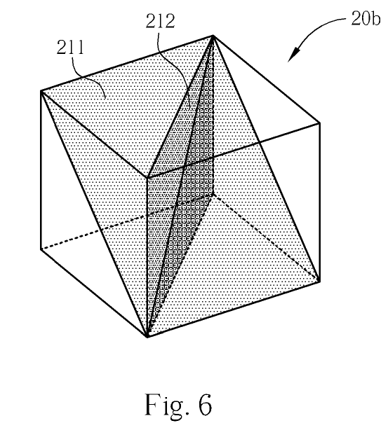

Please refer to FIG. 5 and FIG. 6. FIG. 5 is a perspective diagram showing the illumination system 10b for projection apparatuses and FIG. 6 is a three-dimensional diagram showing the light combination device 20b. According to the third embodiment of the present invention, red, green, and blue light beams are emanated from the R/G/B-LED light source arrays 12, 14, 16 and combined to form a white-light source by the light combination device 20b. As shown in FIG. 5, the R-LED light source array 12 includes a curved substrate 121 and a plurality of R-LEDs 122 fixed on the curved substrate 121. The G-LED light source array 14 includes a curved substrate 141 and a plurality of G-LEDs 142 fixed on the curved substrate 141. The B-LED light source array 16 includes a curved substrate 161 and a plurality of B-LEDs 162 fixed on the curved substrate 161.

According to the third embodiment of the present invention, the curved substrates 121, 141, and 161 are mirror substrates with equal curvatures positioned in a corresponding manner around the light combination device 20b, where the maximum light intensity axial of the R-LED 122 is roughly pointed toward the center of the light combination device 20b. It should be noted that the substrates 121, 141, and 161 of the R/G/B-LED light source arrays 12, 14, 16 of illumination system 10b can also be flat substrates instead of curved substrates. Alternatively, a similar effect can be achieved by changing the arrangement of the light-emitting diodes 122 such as tilting the diodes at an angle, thereby causing the maximum light intensity axial to point toward the center of the light combination device 20b.

As shown in FIG. 6, the light combination device 20a can be a traditional horizontal crossed prism or a so-called “X-Plate” light combination prism component. By using the X-Plate light combination prism component as an example, the X-Plate light combination prism component includes a light converting surface 211 that enables the reflection of blue light beams and the penetration of green light beams and a light converting surface 212 that enables the reflection of red light beams and the penetration of green light beams. By combining the red, green, and blue light beams emanated from the R/G/B-LED light source arrays 12, 14, 16 via the light combination device 20a, a white light beam 30 is generated and transmitted back to a polarity conversion and energy recycling system 50, which can be a combination of lens array and PCS or a recyclable light pipe device. After exiting from the polarity conversion and energy recycling system 50, the polarized beams are transmitted through the lens group and an optical engine 60 and finally projected to a screen by the projection lens (not shown).

According to the present invention, the light source can be applied to illumination systems with various kinds of light valves. In addition, the corresponding location of the R-LED source array, the G-LED source array, and the B-LED source array can be adjusted according to the reflective property of the light combination device, which is unattainable by the prior art. Also, the substrate surface regarding to the arrangements of the LED source array can also be selected from different curving surfaces such as parabolic, elliptical, spherical, or non-spherical according to the dispersion angle of the single LED light source.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An illumination system for projection apparatuses comprising a red light-emitting diode (R-LED) light source array, a green light-emitting diode (G-LED) light source array, and a blue light-emitting diode (B-LED) light source array, in which red, green, and blue light beams are emanated from the R/G/B-LED light source arrays via a light combination device for generating a white-light source.

2. The illumination system of claim 1 wherein each R/G/B-LED light source array includes a substrate and a plurality of light-emitting diodes fixed on the substrate and the light-emitting diodes are positioned toward the light combination device.

3. The illumination system of claim 2 wherein each light-emitting diode comprises a maximum light intensity axial that is pointed toward a center of the light combination device.

4. The illumination system of claim 2 wherein the substrate is a curved substrate.

5. The illumination system of claim 1 wherein the light combination device is a horizontal crossed prism or an x-cube light combination prism component.

6. The illumination system of claim 1 wherein the light combination device is a horizontal crossed reflector or an x-plate light combination component.
